(19) United States
(12) Patent Application Publication
(10) Pub. No.: US 2026/0282011 A1
(43) Pub. Date: Sep. 17, 2026

(54) DCI SIZE ALIGNMENT FOR MULTI-CELL SCHEDULING

(71) Applicant: GOOGLE LLC, Mountain View, CA (US)

(72) Inventors: Chih-Hsiang Wu, Taoyuan City (TW); Kao-Peng Chou, Taoyuan City (TW)

(21) Appl. No.: 19/157,302

(22) PCT Filed: Feb. 19, 2024
(86) PCT No.: PCT/US2024/016408

§ 371 Date: Aug. 15, 2025

Related U.S. Application Data
(60) Provisional application No. 63/485,874, filed on Feb. 17, 2023.

(51) Int. Cl. H04W 72/1273; H04W 72/232

(52) U.S. Cl. CPC H04W 72/1273; H04W 72/232

(57) ABSTRACT

A user equipment (UE) receives, from a radio access network (RAN), a multi-cell scheduling configuration including a scheduling cell and one or more co-scheduled cells, the receiving of the multi-cell scheduling configuration scheduled by a downlink control information (DCI) in a first DCI format. The UE receives, from the RAN, an indication of a reference cell for muti-cell scheduling; and monitors, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference cell is activated.

### CROSS-REFERENCE TO RELATED APPLICATION

This application claims priority to and the benefit of the filing date of provisional U.S. Patent Application No. 63/485,874, titled “DCI Size Alignment for Multi-Cell Scheduling DCI Format,” filed on Feb. 17, 2023. The entire contents of the provisional application are hereby expressly incorporated herein by reference.

### FIELD OF THE DISCLOSURE

This disclosure relates to wireless communications and, more particularly, to support multi-cell scheduling among multiple carrier frequencies and frequency bands.

### BACKGROUND

The 3rd Generation Partnership Project (3GPP) organization introduced a new scheduling mechanism for multi-carrier enhancement for Release 18 of the 5G new radio (NR) standard. In particular, to make utilization of physical downlink control channel (PUCCH) resources more efficient when aggregating multiple bands, 3GPP introduced a new downlink control information (DCI) format, so that a DCI can simultaneously schedule multiple Physical Downlink Shared Channel (PDSCH) transmission(s) on multiple carriers, which also can be referred to as different cells and/or bands. In different documents, this DCI is referred to as a “multi-carrier DCI” or a “multi-cell scheduling DCI.” For simplicity, the discussion below refers this DCI format as the “multi-cell scheduling” DCI format. On the other hand, the discussion refers to the legacy DCI formats (e.g., DCI formats 0_0, 1_0, 0_1, 1_1, 0_2, 1_2) as “single-cell scheduling” DCI formats.

To utilize multi-cell scheduling, a base station configures a user equipment (UE) with a set of co-scheduled cell(s) and a scheduling cell, as a part of the cell group configuration(s). The UE then may attempt to receive a multi-cell scheduling DCI on the scheduling cell. The multi-cell scheduling DCI schedules PDSCH transmission(s) on the co-scheduled cells(s), and the UE can receive the PDSCH transmission(s) according to the schedule of the multi-cell scheduling DCI. The base station can configure the scheduling cell as one of the cell in the set of co-scheduled cell(s), or a cell that is not in the set of co-scheduled cell(s).

For each cell, 3GPP restricts the number of different DCI sizes a UE is allowed to monitor (see clause 7.3.1.0 in 3GPP TS 38.212). 3GPP also specifies a DCI size alignment procedure for modifying DCI size of some DCI formats, when the number of DCI sizes to monitor exceeds the limit. In general, the UE cannot monitor more than four DCI sizes on a cell, where three of these four DCI sizes correspond to DCI formats with cyclic redundancy check (CRC) scrambled with the cell radio network temporary identifier (C-RNTI). For example, if radio resource control (RRC) signaling configures a UE to monitor a DCI with five possible DCI sizes, the UE applies the DCI size alignment procedure to modify the DCI size of one DCI format (by zero padding or DCI field truncation) to match the DCI size of another DCI format. In this manner, the UE reduces the total number of DCI sizes to monitor down to four, to thereby comply with the 3GPP-specified restriction.

The UE and the base station calculate the number of DCI sizes on each scheduled cell. In legacy cross-carrier scheduling in carrier aggregation (CA) scenarios, even though the base station sends a single cell scheduling DCI on the scheduling cell, the UE and the base station calculate the DCI size of the cross scheduling DCI format on the scheduled cell. This design choice helps the UE to balance the per-cell DCI size monitoring capability in CA scenarios.

However, in multi-cell scheduling scenarios, there are multiple scheduled cells, or a set of co-scheduled cells. Determining the DCI size for the multi-cell scheduling DCI format on each co-scheduled cell would be a waste of UE resources. For this reason, 3GPP has agreed that the base station should indicate a reference cell within the the set of cells for multi-cell scheduling, and the base station and UE can determine the DCI size for the multi-cell scheduling DCI format on the reference cell.

Nevertheless, some aspects of the DCI size alignment procedure for the multi-cell scheduling DCI format are still unclear. First, the base station uses the same single-cell scheduling DCI format for self-scheduling and cross-carrier scheduling, but uses a different DCI format for multi-cell scheduling. It is unclear whether a UE can receive the multi-cell scheduling DCI when the scheduling cell is the only cell the base station can schedule, or when the base station cannot schedule any cells. This lack of clarity also impacts the determination when and how the base station and/or the UE should apply the DCI size alignment procedure to align a single-cell scheduling format with another single-cell scheduling DCI format or with the multi-cell scheduling DCI format, for example.

Further, the base station can activate or deactivate one or more secondary cell (SCell(s)) in the set of cells included in multi-cell scheduling, using radio resource control (RRC) signaling or media access control-control element (MAC-CE). It is unclear how the UE should apply the DCI size alignment procedure when the base station deactivates the reference cell.

### SUMMARY

An example embodiment of the techniques of this disclosure is a method implemented in a user equipment (UE). The method comprises receiving, from a radio access network (RAN), a multi-cell scheduling configuration including a scheduling cell and one or more co-scheduled cells, the receiving of the multi-cell scheduling configuration scheduled by a downlink control information (DCI) in a first DCI format; receiving, from the RAN, an indication of a reference cell for muti-cell scheduling; and monitoring, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference cell is activated.

Another example embodiment of these techniques is a method implemented in a radio access network (RAN). The method comprises transmitting, to a user equipment (UE), a multi-cell scheduling configuration including a scheduling cell and one or more co-scheduled cells, including scheduling the transmitting of the multi-cell scheduling configuration with a downlink control information (DCI) in a first DCI format; transmitting, to the UE, an indication of a reference cell for muti-cell scheduling; and transmitting, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference is activated.

Still another example embodiment of these techniques is a device comprising a transceiver and processing hardware. The device is configured to implement one of the methods above.

### BRIEF DESCRIPTION OF THE DRAWINGS

FIG. 1A is a block diagram of an example wireless communication system in which a RAN and/or a UE implement the techniques of this disclosure for managing multi-cell scheduling;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIG. 3A-C are messaging diagrams of examples scenarios in which SCell activation command(s) trigger a UE to receive DCI(s) in the multi-cell scheduling DCI format;

FIGS. 3D and 3E are messaging diagrams of examples scenarios in which multi-cell scheduling configuration(s) trigger a UE to receive DCI(s) in the multi-cell scheduling DCI format;

FIGS. 4A and 4B are messaging diagrams of example scenarios in which a base station deactivates the reference cell;

FIGS. 5A and 5B are messaging diagrams of example scenarios in which the scheduling cell is the last active cell for multi-cell scheduling;

FIGS. 6A, 6B, and 6C are flow diagrams of example methods according to which a UE determines the single-cell scheduling DCI format size in accordance with SCell activation command(s) and multi-cell scheduling configuration(s);

FIG. 7 is a flow diagram of an example method in which a UE determines the single-cell scheduling DCI format size when receiving SCell deactivated command(s) from a base station;

FIGS. 8A, 8B, and 8C are flow diagrams of example methods in which a base station determines the single-cell scheduling DCI format size in accordance with SCell activation command(s) and multi-cell scheduling configuration(s); and

FIG. 9 is a flow diagram of an example method in which a base station determines the single-cell scheduling DCI format size when sending SCell deactivation command(s) to a UE.

### DETAILED DESCRIPTION OF THE DRAWINGS

Generally speaking, the techniques of the disclosure introduce a mechanism for a UE to perform the DCI size alignment procedure when the UE is configured, by a base station, to monitor multi-cell scheduling DCI format(s). Multi-cell scheduling involves multiple cell operations, e.g., serving cell addition, removal, activation, deactivation, changing of reference cell, etc. Each of the operations impacts the way UE and base station determining DCI size of a DCI format, where the DCI size is an essential information to decode a DCI from signals received on PDCCH.

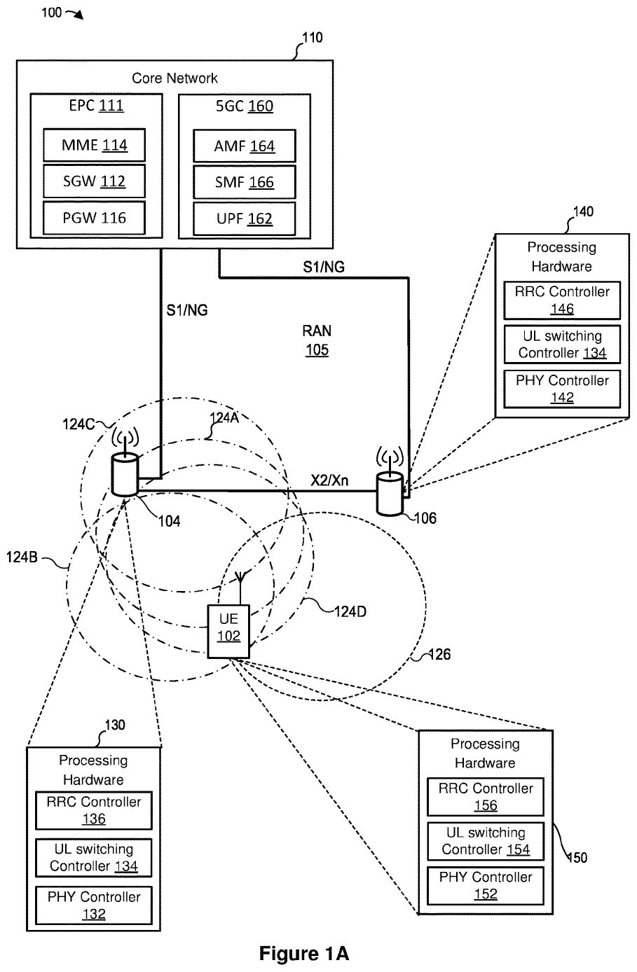

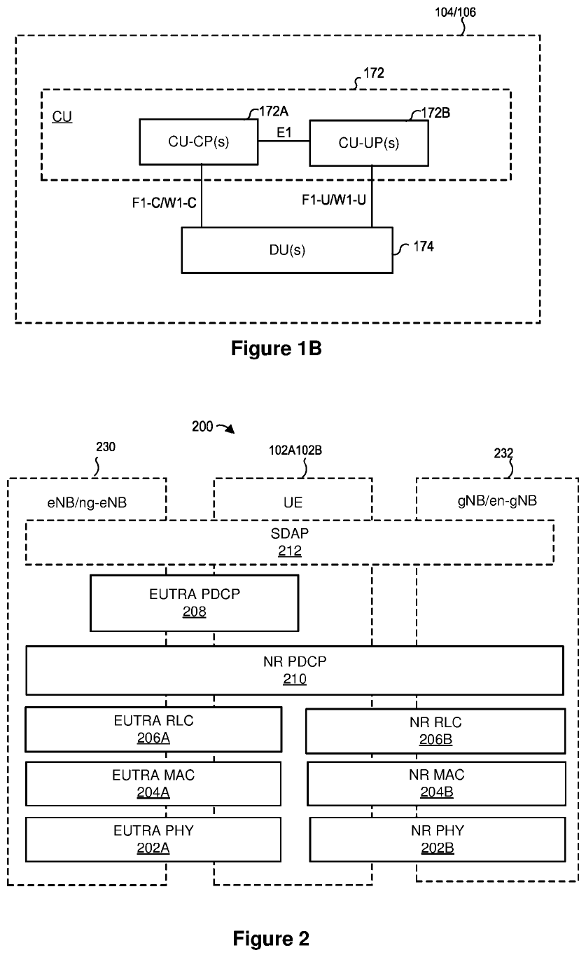

FIG. 1A depicts an example wireless communication system 100 that can implement multi-cell scheduling of this disclosure. The wireless communication system 100 includes UE 102, as well as base stations 104, 106A, 106B of a radio access network (RAN) (e.g., RAN 105) that are connected to a core network (CN) 110. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE multi-cell scheduling controller 152 that is configured to manage UE receiving multi-cell scheduling DCI format(s) and multi-cell PDSCH transmission(s). For example, the UE multi-cell scheduling controller 152 can be configured to support RRC configurations, procedures and messaging associated with multi-cell scheduling, DCI size alignment procedures, and/or to support the necessary operations, as discussed below.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, and 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the multi-cell scheduling control information.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB 230 or a gNB 232 (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can application content for different services, e.g., IPv4/IPv6 multicast delivery, IPTV, software delivery over wireless, group communications, IoT applications, V2X applications, and/or emergency messages related to public safety.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as a MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

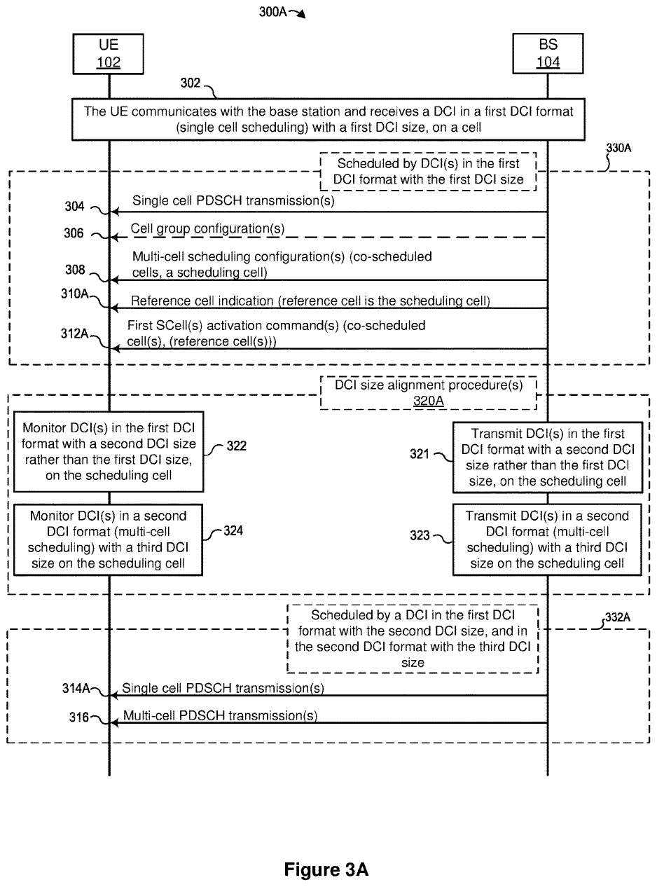

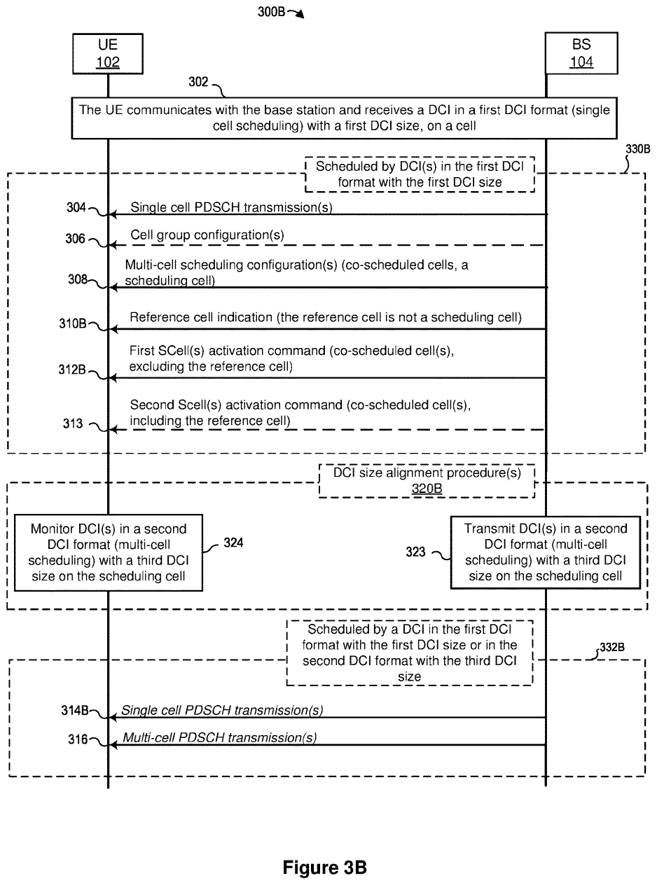

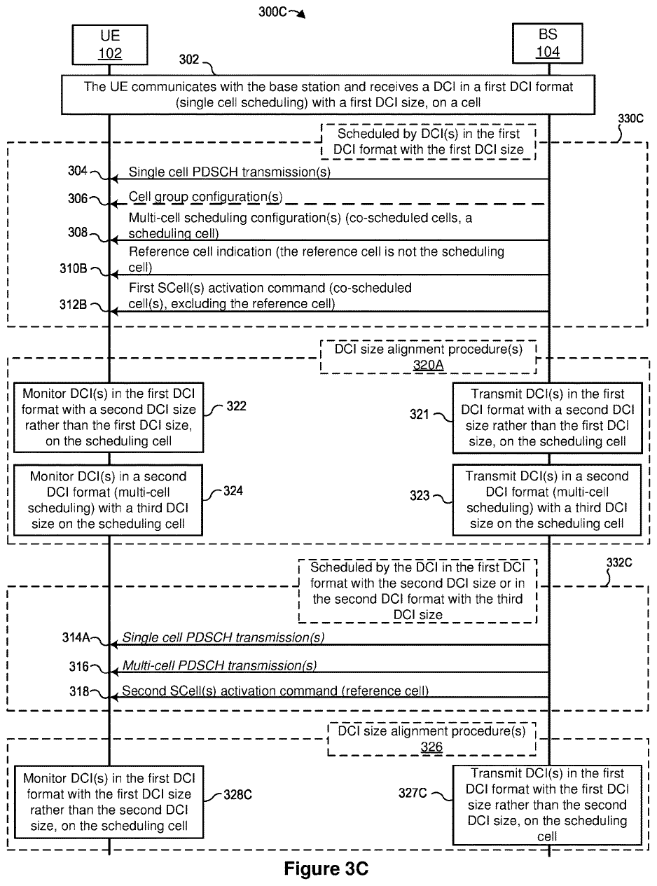

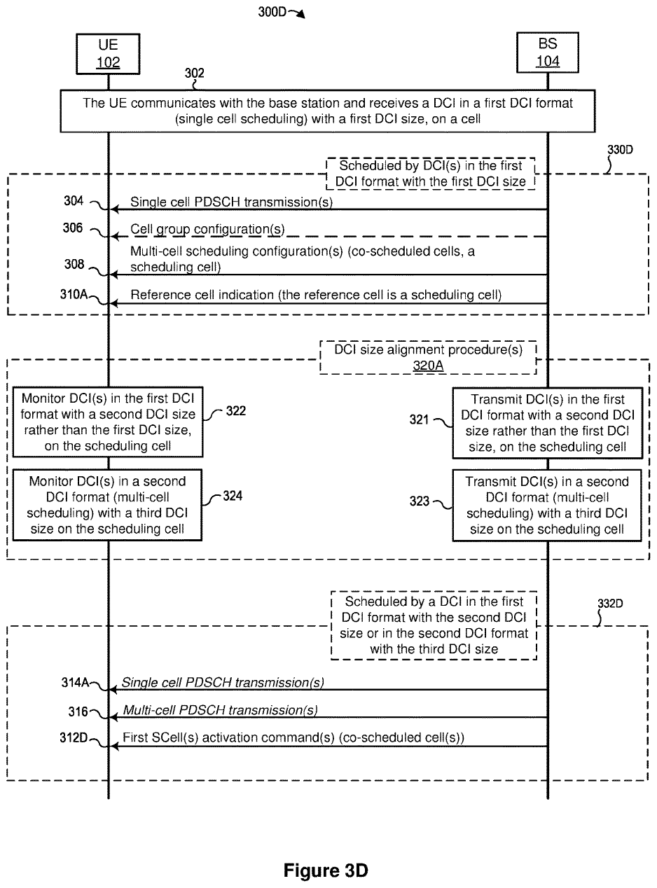

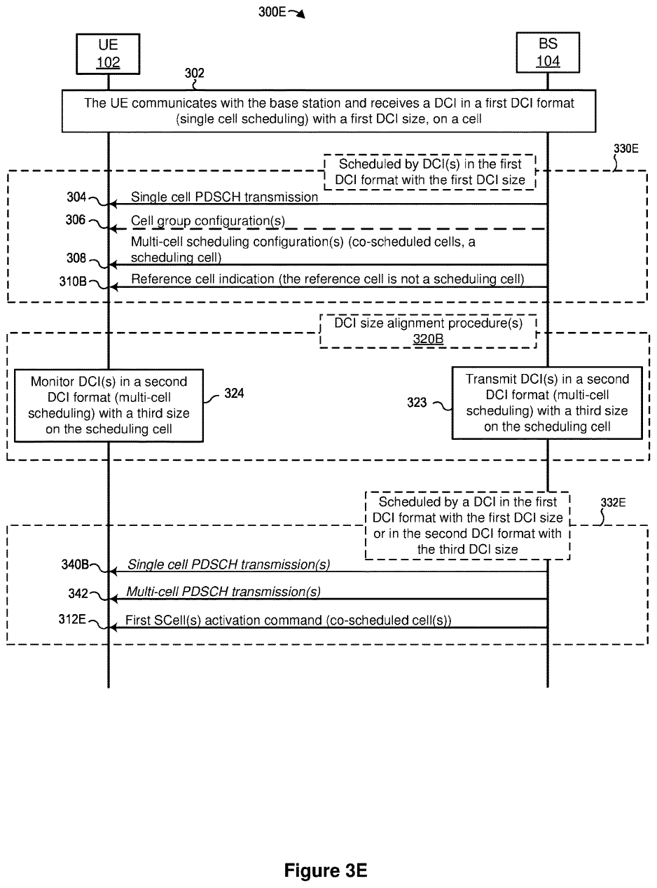

FIGS. 3A-5B are messaging diagrams of example scenarios 300A-500B in which a base station and UE implement the techniques of this disclosure to support multi-cell scheduling. Generally speaking, events in FIGS. 3A-5B that are similar are labeled with similar reference numbers (e.g., event 330A is similar to events 330B, 330C, 330D, 330E, etc., event 318 is similar to events 418, 518, etc., and event 460A is similar to events 460B, 560A, 560B, etc.), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to a scenario 300A illustrated in FIG. 3A, the UE 102 initially communicates 302 with the base station 104 and receives DCI(s) in a first DCI format (which in this example is a single-cell scheduling DCI format), with a first DCI size, on a certain cell. A DCI in the first DCI format can schedule one PDSCH transmission on the cell to support self-scheduling, or another cell to support cross-carrier scheduling. The base station 104 can send 330A various control plane and user plane packets, to the UE 102 using DCI(s) in the first DCI format with the first DCI size. For example, the base station 104 transmits 304 a single cell PDSCH transmission(s) to the UE 102, using a DCI in the first DCI format with the first DCI size.

The base station 104 transmits 306 one or more cell group configuration(s) to the UE 102, to configure the UE 102 to communicate with the RAN 105 via multiple cells (e.g., using carrier aggregation). In some implementations, if the UE 102 has been configured with carrier aggregation, and the base station 104 determines to refrain from reconfiguring the cell group configuration(s) for multi-cell scheduling, the base station 104 may not transmit 306 the cell group configuration(s) to the UE 102.

The base station 104 transmits 308, to the UE 102, one or more multi-cell scheduling configuration(s) that indicate (i) a scheduling cell on which the UE 102 can receive DCI(s) in a second DCI format, and (ii) at least one co-scheduled cell a DCI(s) in the second DCI format can schedule. The second DCI format is a multi-cell scheduling DCI format, in which a DCI schedules at least one PDSCH(s) on at least one cell(s). According to the multi-cell scheduling configuration(s) of the event 308, the scheduling cell can be a co-scheduled cell or a cell other than a co-scheduled cell. In the example scenario 300A, the base station 104 configures the cell with which the UE 102 communicates 302, 304, as the scheduling cell.

The base station 104 transmits 310A a reference cell indication to the UE 102, to indicate the reference cell. The UE 102 determines the DCI size of the second DCI format during a DCI size alignment procedure based on the reference cell indication. The reference cell is a cell of the co-scheduled cell(s) configured as a part of the event 308. In the scenario 300A, the reference cell indicated in the event 310A is the scheduling cell, and thus the reference cell can be a PCell, PSCell, or an SCell configured as a scheduling cell. In some implementations, at the time when the UE 102 receives 310A, the scheduling cell (which in this case is also the reference cell) is the only active cell in a set of cells for multi-cell scheduling configured in event 308. In some implementations, the scheduling cell (which is also the reference cell) is active when the UE 102 receives 310A.

The base station 104 transmits 312A a first SCell(s) activation command(s) to the UE 102 to activate at least one co-scheduled cell(s). In response to receiving 312A the activation command, the UE 102 activates co-scheduled cell(s)/SCell(s). The activation command may trigger the UE 102 to monitor the second DCI format. For example, in some implementations, the UE 102 starts to monitor the second DCI format if the scheduling cell is activated. In some implementations, the UE 102 starts to monitor the second DCI format if the scheduling cell and the reference cell are activated.

In some implementations, the UE 102 starts to monitor the second DCI format if the scheduling cell is activated, and the scheduling cell is one of the co-scheduled cell(s). In some implementations, the UE 102 starts to monitor the second DCI format if the scheduling cell and a co-scheduled cell are activated, where the co-scheduled cell is not the scheduling cell or the reference cell. If, in some implementations, the scheduling cell (also the reference cell) is not the only active cell in a set of cells for multi-cell scheduling at the time when the UE 102 receives 310A, and the active cell(s) satisfies the UE requirement to monitor the second DCI format, the UE the events 308 and/or 310A can trigger the UE 102 to monitor the second DCI format, without receiving SCell activation command(s).

After the UE 102 determines to monitor the second DCI format, the UE 102 performs 320A DCI size alignment procedure to ensure that the number of monitored DCI sizes per cell complies with the standard, agreement, or a configuration to which the RAN 105 also conforms, e.g., the relevant 3GPP standard. If the number of monitored DCI sizes of a cell (e.g., the scheduling cell and/or the reference cell indicated in the events 308 and 310) exceeds the restriction (e.g., four sizes) in the relevant standard, the UE 102 applies bits padding and truncation to some of the monitored DCI format(s) (e.g., the first DCI format, the second DCI format, etc.) to reduce the number of monitored DCI sizes. For example, the UE 102 may monitor the first DCI format in a DCI size identical to the DCI size of another single/multiple cell scheduling DCI format instead of the original DCI size.

Similarly, after the base station 104 performs 320A DCI size alignment procedure, if the number of DCI sizes to be transmitted on a cell (e.g., the scheduling cell and/or the reference cell indicated in events 308 and 310) exceeds the restriction (e.g., four sizes) in the 3GPP standard or a configuration, the base station 104 applies padding and truncation to some of the DCI format(s) to be transmitted on the cell (e.g., the first DCI format, the second DCI format, etc.) to satisfy the restriction. For example, the base station 104 may transmit the first DCI format with a DCI size identical to another single/multiple cell scheduling DCI format instead of the original DCI size. In some implementations, the base station 104 performs 320A the DCI size alignment procedure after confirming that the UE 102 has been triggered to monitor the second DCI format. To this end, the base station 104 can receive, from the UE 102, HARQ feedback corresponding to the events 308, 310A, or 312A, for example.

Referring to event 321, because the DCI size of the second DCI format is determined based on the reference cell, and the reference cell in the scenario 300A is the scheduling cell, the total number of DCI size the UE 102 monitors n the scheduling cell may exceed the 3GPP restriction. Thus, as a result of executing the procedure 320A, the base station 104 starts to transmit, to the UE 102, DCI(s) in the first DCI format with a second DCI size instead of using the first DCI size on the scheduling cell. In event 323, the base station 104 starts to transmit, to the UE 102, DCI(s) in a second DCI format with a third DCI size on the scheduling cell as another result of executing the procedure 320A. For example, if the base station 104 is configured to transmit a DCI on a PDCCH to the UE 102, the base station 104 uses the second DCI size to determine the codeword length to encode the DCI (e.g., encoded by polar code, block code, LDPC, etc.). Next, the base station 104 uses the codeword length and the length of the PDCCH resource (e.g., number of bits that can carried by the allocated control-channel elements (CCE) to the PDCCH) to determine the rate matching mechanism (e.g., repetition, puncturing, or shortening.). The base station 104 then transmits the DCI on the PDCCH to the UE 102.

Similarly, referring to event 322, because the DCI size of the second DCI format is determined based on the reference cell, and the reference cell is the scheduling cell in the scenario 300A, the total number of DCI size the UE 102 monitors on the scheduling cell may exceeds the 3GPP restriction. Thus, as a result of executing the procedure 320A, the UE 102 starts to receive, from base station 104, DCI(s) in the first DCI format with a second DCI size rather than the first DCI size on the scheduling cell.

The the UE 102 monitors 324 (e.g., starts to receive), from the base station 104, DCI(s) in a second DCI format with a third DCI size, on the scheduling cell. For example, the UE 102 receives a sequence of bits from a PDCCH from the base station 104, and uses the second DCI size to determine the codeword length of the encoded DCI (e.g., encoded by polar code, block code, LDPC, etc.) carried by the PDCCH. Next, the UE 102 uses the codeword length and the length of the sequence (e.g., number of bits that can carried by the allocated control-channel elements (CCE) to the PDCCH) to determine the rate matching mechanism (e.g., repetition, puncturing, or shortening.). Then, the UE 102 can use this information to decode the codeword, determine the DCI format (e.g., the first DCI format), and read the DCI.

Based on the results of the procedure 320A (e.g., events 321, 322, 323, and 324), the base station 104 can schedule 332A PDSCH transmission(s) to the UE 102 using DCI(s) in the first DCI format with the second DCI size, and in the second DCI format with the third DCI size. For example, the base station 104 transmits 314A, to the UE 102, single cell PDSCH transmission(s) by using DCI(s) in the first DCI format with the second DCI size. The base station 104 transmits 316, to the UE 102, multi-cell PDSCH transmission(s) by using DCI(s) in the second DCI format with the third DCI size.

In some implementations, the cell on which the UE 102 communicates 302, 330 with the base station 104 is not configured (e.g. in event 308) as the scheduling cell. In this case, the first DCI format of the events 302 and 330 can be the same or different from the first DCI format in events 320 and 332A. Also, in this case, the first DCI size of the events 302 and 330 can be the same or different from the first DCI size in events 320 and 332A

In some implementations, the second DCI size is identical to the third DCI size. In other implementations, the second DCI size is different from the third DCI size.

Referring to FIG. 3B, a scenario 300B is generally similar to the scenario 300A, but there the base station 104 transmits 310B a reference cell indication to the UE 102, where the indicated reference cell is neither an active cell nor the scheduling cell. The base station 104 transmits 312B, to the UE 102, a first SCell(s) activation command to activate at least one co-scheduled cell excluding the reference cell. the base station 104 then transmits 313, to the UE 102, a second SCell(s) activation command to activate at least one co-scheduled cell including the reference cell.

In some implementations, the UE 102 starts to monitor the second DCI format if the scheduling cell and the reference cell are activated. In this case, in response to the event 313, the UE 102 determines to monitor the second DCI format and performs 320B DCI size alignment. Similarly, the base station 104 performs 320B DCI size alignment after confirming that the UE 102 has determined to monitor the second DCI format.

In some implementations, the UE 102 starts to monitor the second DCI format if the scheduling cell and a co-scheduled cell that is neither the scheduling cell nor the reference cell are activated. In this case, instead of triggering based on the event 313, the UE 102 determines to monitor the second DCI format and performs 320B the DCI size alignment procedure per the event 312B.

In some implementations, if at the time when the UE 102 receives 310B the reference cell is active, the UE 102 starts to monitor the second DCI format in response to the event 310B.

Unlike the scenario 300A, the DCI size of the second DCI format is determined based on the reference cell, and thus the number of DCI sizes monitored on the scheduling cell remains the same. Thus, a DCI size alignment procedure 320B includes only events 323 and 324 on the scheduling cell. As a result, the UE 102 continues receiving, from the base station 104, DCI(s) in the first DCI format with the first DCI size. However, if the number of monitored DCI sizes monitored on the reference cell exceeds the restriction of 3GPP standard, the procedure 320B can include events similar to 321 and 322, and the UE 102 starts to receive, from the base station 104 on the reference cell, DCI(s) of a DCI format with a different DCI size instead of the original DCI size.

Based on the result of executing 320B the DCI size alignment procedure, the base station 104 can schedule 332B, to the UE 102, PDSCH transmission(s) using DCI(s) in the first DCI format with the first DCI size and the second DCI format with the second DCI size on the scheduling cell. For example, the base station 104 schedules 314B single cell PDSCH transmission(s) by using the first DCI format with the first DCI size.

Referring now to FIG. 3C, a scenario 300 is generally similar to the events in the scenario 300A and 300B, except that if the reference cell is not activated by the first activation command (e.g., 312B), the UE 102 and the base station 104 use the scheduling cell as the reference cell for DCI size alignment procedure(s). For example, in response to the first SCell(s) activation command of the event 312B, activating co-scheduled cell(s) excluding reference cell, the UE 102 and the base station 104 perform 320A DCI size alignment procedure(s). Event 332C is similar to event 332A, except that the UE 102 receives, from the base station 104, 318 a second SCell(s) activation command that activates the reference cell. In response to the event 318, the UE 102 and the base station 104 perform 326 DCI size alignment procedure(s). In the event 327C, the base station 104 starts to transmit, to the UE 102, DCI(s) in the first DCI format with the first DCI size instead of using the second DCI size on the scheduling cell as an outcome of event 326. In the event 328C, the UE 102 starts to receive, from the base station 104, DCI(s) in the first DCI format with the first DCI size instead of using the second DCI size on the scheduling cell as an outcome of event 326. Then the UE 102 can receive, from the base station 104, PDSCH transmission(s) similar to event 332B.

Referring to a FIG. 3Da scenario 300D is generally similar to the scenario 300A, except that here the UE 102 starts to monitor the second DCI format in response to receiving 308 multi-cell scheduling configuration(s) and/or 310A reference cell indication, instead of the SCell activation command (e.g., 312A). Thus, in the event 330D, the base station 104 does not transmit a SCell activation command to the UE 102. Instead, in the event 332D, the UE 102 can receive, from the base station 104, 312D a first SCell activation command(s) activating co-scheduled cell(s), which is carried by PDSCH transmission(s) scheduled by DCI(s) in the first DCI format with the second DCI size or in the second DCI format with the third DCI size.

Referring to FIG. 3E, a scenario 300E is generally similar to the scenarios 300B and 300D, except that here the UE 102 receives 330E, from the base station 104, 310B a reference cell indication that the indicated reference cell is not the scheduling cell. Thus, the UE 102 and the base station 104 perform 320B DCI size alignment procedure(s) in response to events 308 and 310B. In event 332E, the UE 102 receives, from the base station 104, 312E a first SCell activation command(s) activating co-scheduled cell(s), which can be carried by PDSCH transmission(s) scheduled by DCI(s) in the first DCI format with the first DCI size and in the second DCI format with the third DCI size.

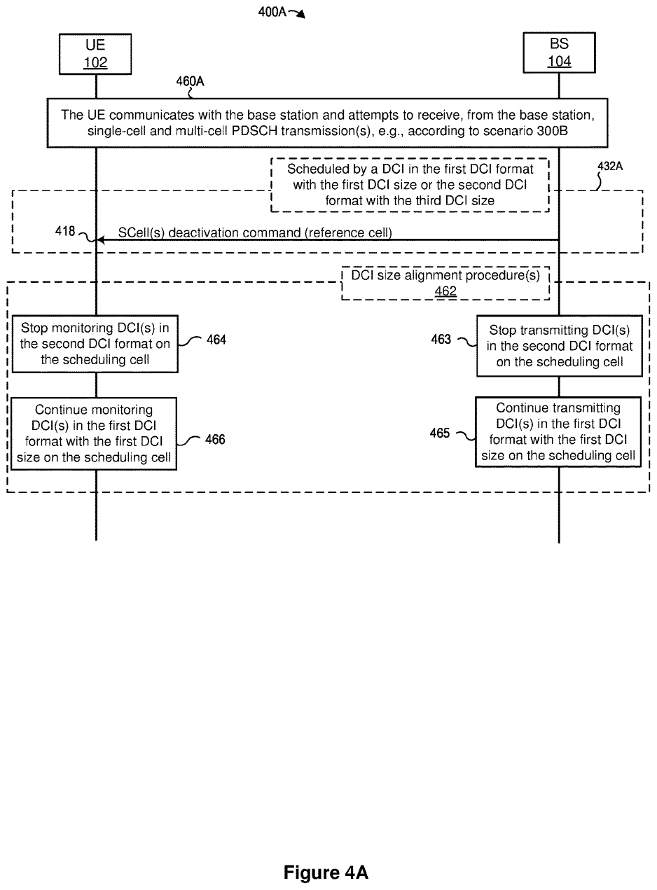

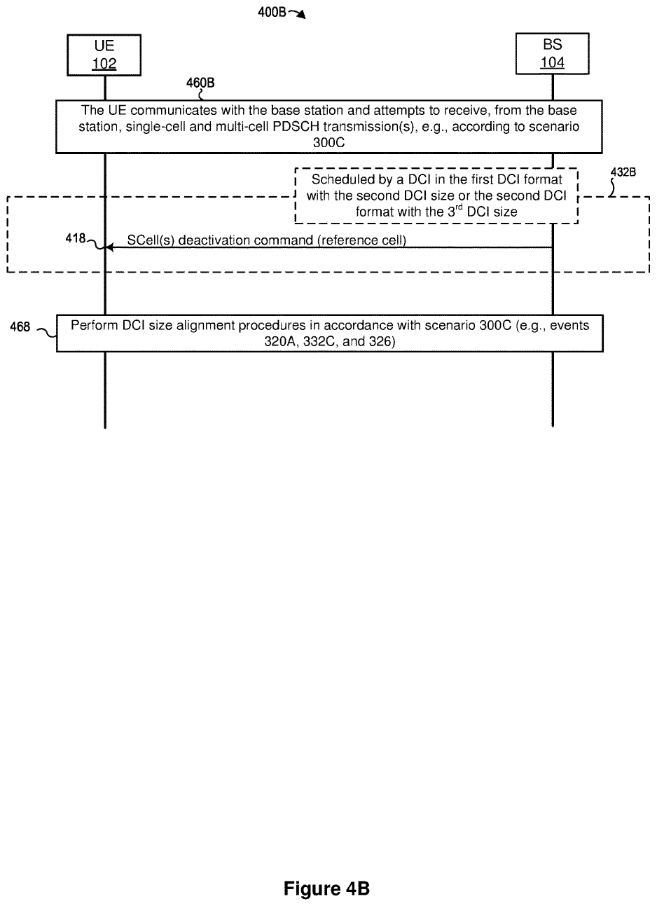

Referring to a scenario 400A illustrated in FIG. 4A, the messaging starts at event 460A, where the UE 102 communicates with the base station 104 and attempts to receive single-cell and multi-cell PDSCH transmission(s), e.g., similar to the scenario 300B. The UE 102 can receive 430A PDSCH transmission(s) scheduled by DCI(s) in the first DCI format with the first DCI size or in the second DCI format with the third DCI size. In one example, the UE 102 receives 418, from the base station 104, an SCell(s) deactivation command deactivating the reference cell.

In response to the receiving 418 of the SCell deactivation command, the base station 104 performs 462 DCI size alignment procedure(s). The the base station 104 stops 463 transmitting, to the UE 102, DCI(s) in the second DCI format on the scheduling cell as a result of performing 462 the DCI size alignment procedure. The base station 104 however continues 465 transmitting, to the UE 102, DCI(s) in the first DCI format with the first DCI size on the scheduling cell (as another result of performing 462 the DCI size alignment procedure). Likewise, in response to the event 418, the UE 102 performs 462 DCI size alignment procedure(s). The UE 102 stops 464 receiving, from the base station 104, DCI(s) in the second DCI format with the third DCI size on the scheduling cell as a part of performing 462 the DCI size alignment procedure. The UE 102 continues 466 receiving, from the base station 104, DCI(s) in the first DCI format with the first DCI size on the scheduling cell (also as a part of performing 462 the DCI size alignment procedure).

After the event 462, if the UE 102 receives, from the base station 104, an SCell activation command similar to event 313 that activates the reference cell, the UE 102 can perform the events in the procedure 300B, e.g., events 320B, 324, 332B, 314B, and 316, to continue receiving single cell and multi-cell PDSCH transmission(s) from the base station 104.

Referring to FIG. 4B, a scenario 400B is generally similar to the scenario 400. Here, however, the UE 102 communicates 460B with a base station 104 and attempts to receive single cell and multi-cell PDSCH transmission(s), e.g., based on events in scenario 300C. The event 432B is similar to event 432A except that the UE 102 monitors DCI(s) in the first DCI format with the second DCI size as an outcome of event 460B. In event 468, the UE 102 performs procedures as events in scenario 300C, e.g., 320A, 332C, and 326, to continue receiving single cell and multi-cell PDSCH transmission(s) from the base station 104.

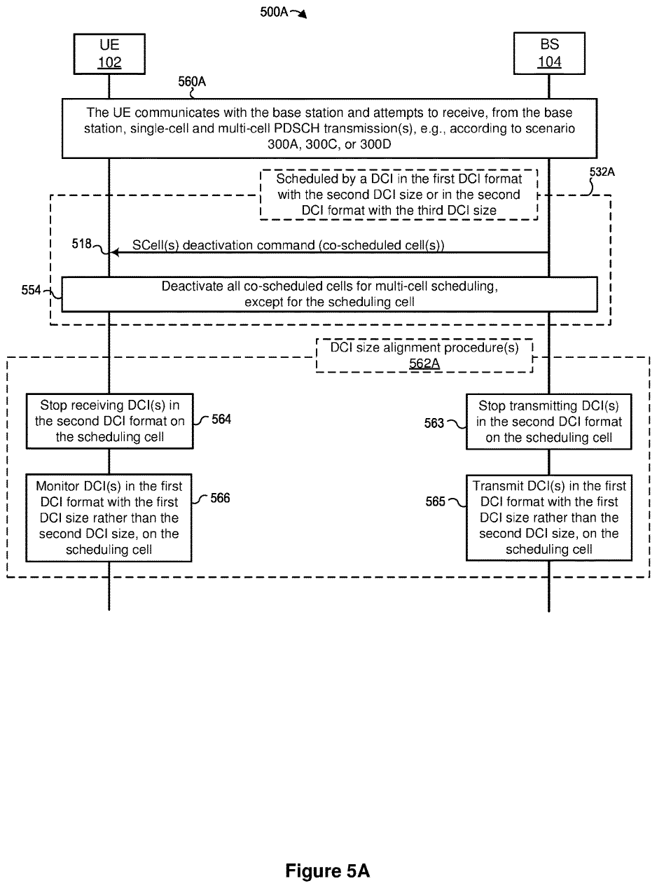

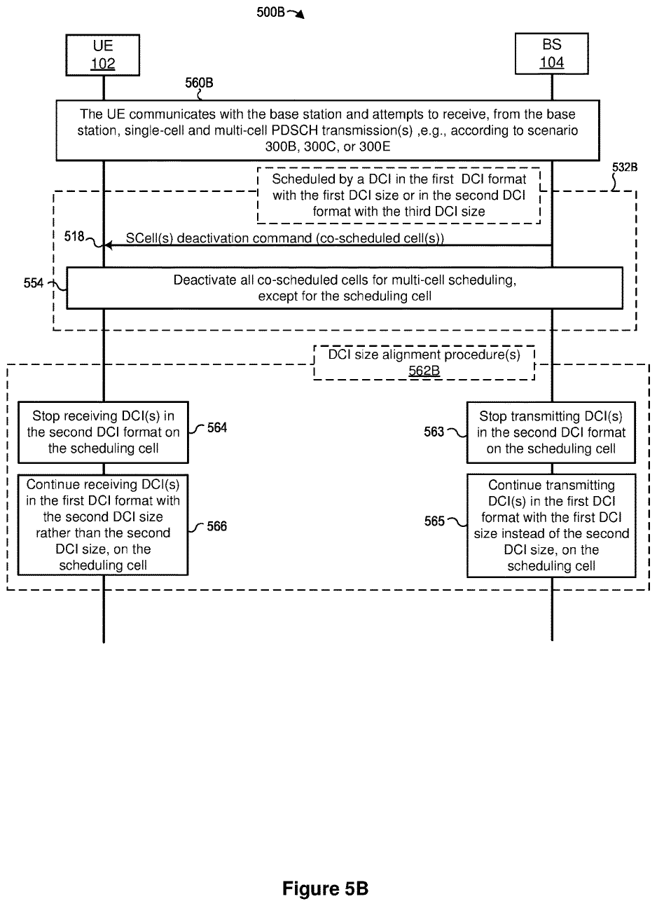

Referring to a scenario 500A illustrated in FIG. 5A, the messaging starts at event 560A, where a UE 102 communicates with a base station 104 and attempts to receive single cell and multi-cell PDSCH transmission(s), e.g., based on events in scenario 300A, 300C, or 300D. As an outcome of event 560A, the UE 102 can receives, from the base station 104, control plane and user plane packets on PDSCH(s) that is, as in event 532A, scheduled by DCI(s) in the first DCI format with the second DCI size or in the second DCI format with the third DCI size.

The UE 102 receives, from the base station 104, 518 a SCell(s) deactivation command deactivating the reference cell. As an outcome of event 518, the UE 102 deactivates SCell(s) which results in event 554 that all co-scheduled cells for multi-cell scheduling, except the scheduling cell, are deactivated. It means that the scheduling cell of the base station 104 can only schedule, to the UE 102, PDSCH transmission(s) on the scheduling cell (refer to self-scheduling).

In response to events 518 and 554, the base station 104 performs 562A DCI size alignment procedure(s). In event 563, the base station 104 stops transmitting DCI(s) in the second DCI format on the scheduling cell as an outcome of event 562A. In event 565, the base station 104 starts to transmit DCI(s) in the first DCI format with the first DCI size, instead of the second DCI size, on the scheduling cell as another outcome of event 562A. Likewise, in response to events 518 and 554, the UE 102 performs 562A DCI size alignment procedure(s). In event 564, the UE 102 stops receiving DCI(s) in the second DCI format on the scheduling cell as an outcome of 562A. In event 566, the UE 102 starts to receive DCI(s) in the first DCI format with the first DCI size, instead of the second DCI size, on the scheduling cell as another outcome of event 562A.

Referring to FIG. 5B, a scenario 500B is generally similar to the scenario 500A, except that here the UE 102 communicates 560B with a base station 104 and attempts to receive single cell and multi-cell PDSCH transmission(s), e.g., based on events in scenario 300B, 300C or 300E. As one of the result of the procedure 560B, the UE 102 can receives, from the base station 104, control plane and user plane packets on PDSCH(s) that is, as in event 532B, scheduled by DCI(s) in the first DCI format with the first DCI size or in the second DCI format with the third DCI size.

In response to the events 518 and 554, the base station 104 performs 562B DCI size alignment procedure. The base station 104 stops 563 transmitting, to the UE 102, DCI(s) in the second DCI format on the scheduling cell as an outcome of event 562B. The base station 104 continues 565 transmitting, to the UE 102, DCI(s) in the first DCI format with the first DCI size on the scheduling cell. Likewise, in response to the events 518 and 554, the UE 102 performs 562B DCI size alignment procedure. The UE 102 stops 564 receiving, from the base station 104, DCI(s) in the second DCI format on the scheduling cell as. The UE 102 continues 566 receiving, form the base station 104, DCI(s) in the first DCI format with the first DCI size on the scheduling cell

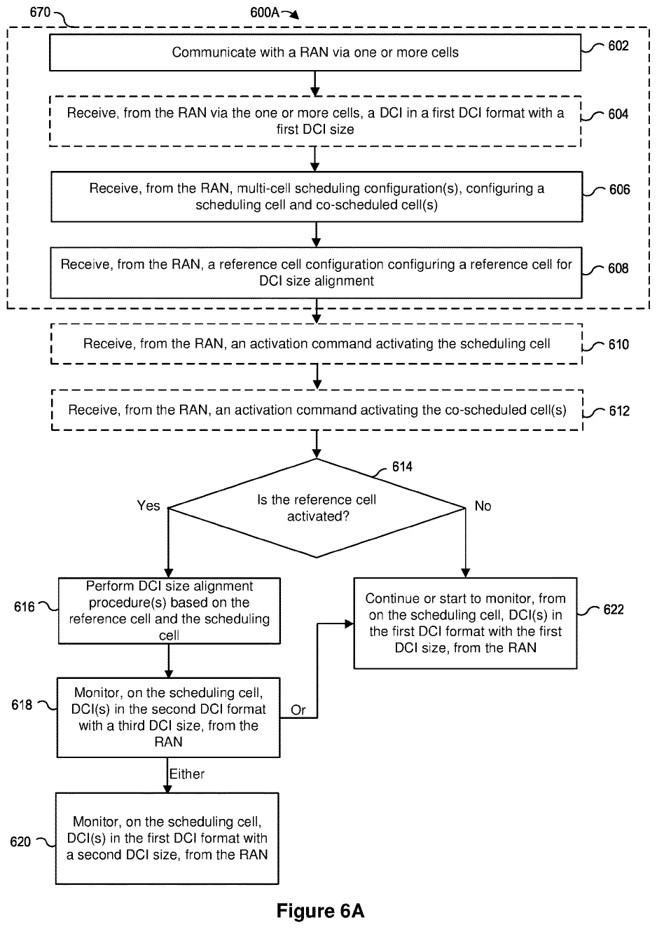

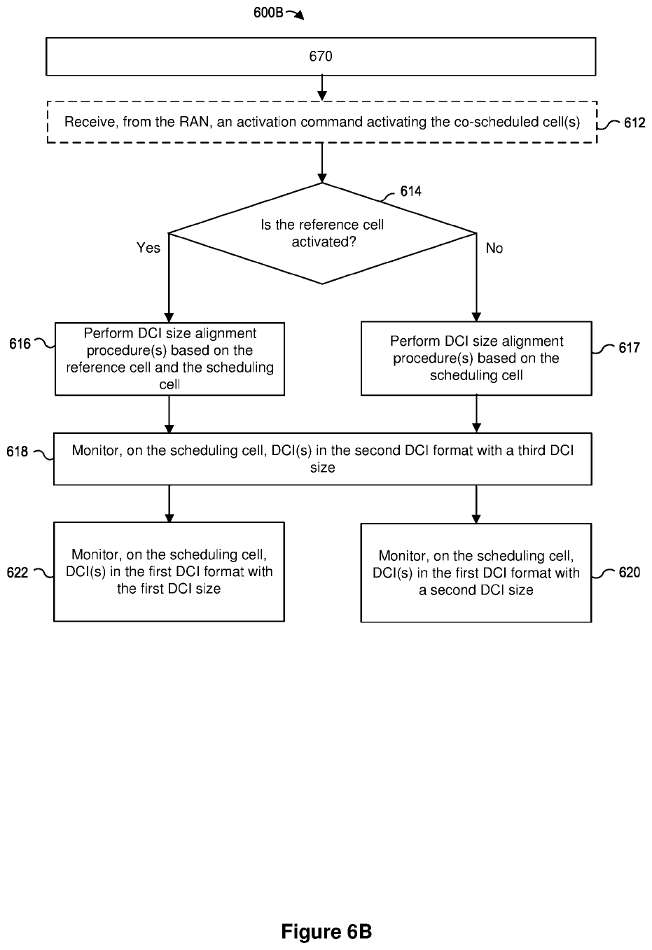

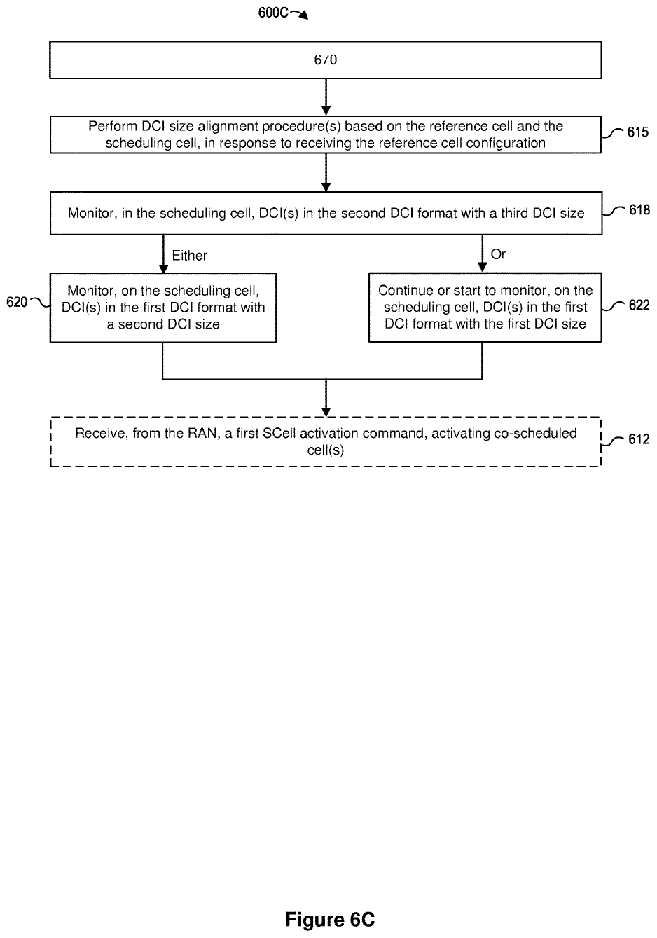

FIGS. 6A-9B are flow diagrams depicting example methods that a base station (e.g., the base station 104 or the DU 174) of a RAN (e.g., the RAN 105) or a UE (e.g., the UE 102) can implement to manage transmission/reception of single cell and multi-cell PDSCH transmission(s).

FIG. 6A is a flow diagram of an example method 600A for receiving single cell and multi-cell PDSCH transmission(s), which can be implemented by a UE. The method 600A begins at block 602, where the UE communicates with a RAN via one or more cells (e.g. event 302). At block 604, the UE receives, from the RAN via the one or more cells, DCI(s) in a first DCI format with a first DCI size (e.g., event 304). At block 606, the UE receives, from the RAN, multi-cell scheduling configuration(s) (e.g., event 308), configuring a scheduling cell and co-scheduled cell(s). At block 608, the UE receives, from the RAN, a reference cell configuration indicating a reference cell for DCI size alignment procedure (e.g., 310A, 310B). At block 610, the UE receives, from the RAN, an activation command activating the scheduling cell (e.g., events 312A, 313). At block 612, the UE receives, from the RAN, an activation command activating the co-scheduled cell(s) (e.g., events 312A, 312B, 313). At block 614, the UE determines whether the reference cell is activated. If the UE determines that the reference cell is activated at block 614, the flow proceeds to block 616. Otherwise if the UE determines that the reference is not activated, the flow proceeds to block 622. At block 616, the UE performs DCI size alignment procedure(s) (e.g., events 320A, 320B, 326) based on the reference cell and the scheduling cell. In some implementations, the DCI size alignment procedures include a first DCI size alignment procedure and a second DCI size alignment procedure. In such cases, the UE performs the first DCI size alignment procedure and the second DCI size alignment procedure based on the reference cell and the scheduling cell, respectively. In other implementations, the UE performs the DCI size alignment procedure (i.e., a single DCI size alignment procedure) based on the both the reference cell and the scheduling cell. At block 618, the UE starts to receive, from the RAN, on the scheduling cell, DCI(s) in the second DCI format with a third DCI size (e.g., event 324). Then the flow can proceed either to the block 620 or the block 622. At block 620, the UE starts to receive, from the RAN on the scheduling cell, DCI(s) in the first DCI format with a second DCI size (e.g., events 322). At block 622, the UE continues or starts to receive, from the RAN on the scheduling cell, DCI(s) in the first DCI format with the first DCI size (e.g., 328C). In some implementations, the UE may skip blocks 610 and 612.

Blocks 602, 604, 606 and 608 are collectively referred to in FIG. 6A as block 670.

FIG. 6B is a flow diagram of an example method 600B similar to the method 600A, except that the method 600B includes a block 617. If the UE determines that the reference cell is not activated at block 614, the flow proceeds to block 617. At block 617, the UE performs a DCI size alignment procedure based on the scheduling cell, then the flow proceeds to blocks 618 and 620. In other words, when the reference cell is deactivated, the UE does not consider the reference cell in the DCI size alignment procedure.

FIG. 6C is a flow diagram of an example method 600C similar to the method 600A, except that the method 600C includes block 615 instead of block 614. At block 615, the UE performs DCI size alignment procedure(s) based on the reference cell and the scheduling cell in response to receiving the reference cell configuration from block 670, i.e., regardless of whether the reference cell is activated or not. The flow then proceeds to block 618. The flow either proceeds to block 620 or block 622 from block 618.

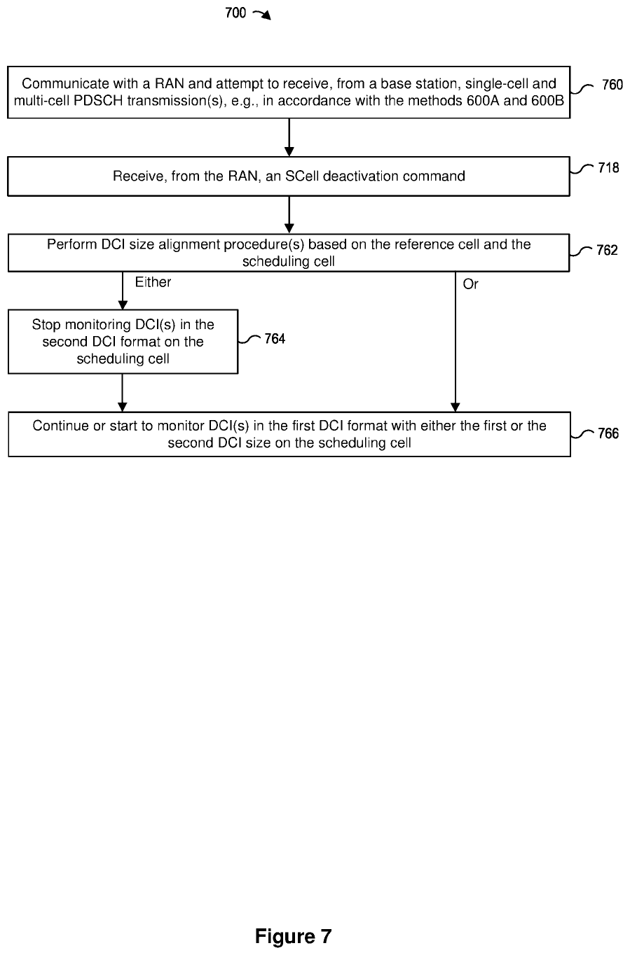

FIG. 7 is a flow diagram of an example method 700 for receiving single cell and multi-cell PDSCH transmission(s), which can be implemented by a UE. The method 700 begins at block 760, where the UE communicates with a RAN, and attempts to receive, from a base station of the RAN, single cell and multi-cell PDSCH transmission(s) by using methods 700. At block 718, the UE receives, from the RAN, a SCell deactivation command (e.g., event 418 and 518). At block 762, the UE perform DCI size alignment procedure(s) (e.g., events 462, 468, 562A, 562B, 616). Based on the outcome of 762, the flow can proceed either to block 764 or block 766. At block 764, the UE stops receiving DCI(s) in the second DCI format on the scheduling cell (e.g., events 464, 564), and the flow proceeds to block 766. At block 766, the UE continues or starts to receive DCI(s) in the first DCI format with either the first (e.g., events 466, 468, 566, 622) or second (e.g., events 468, 620) DCI size on the scheduling cell.

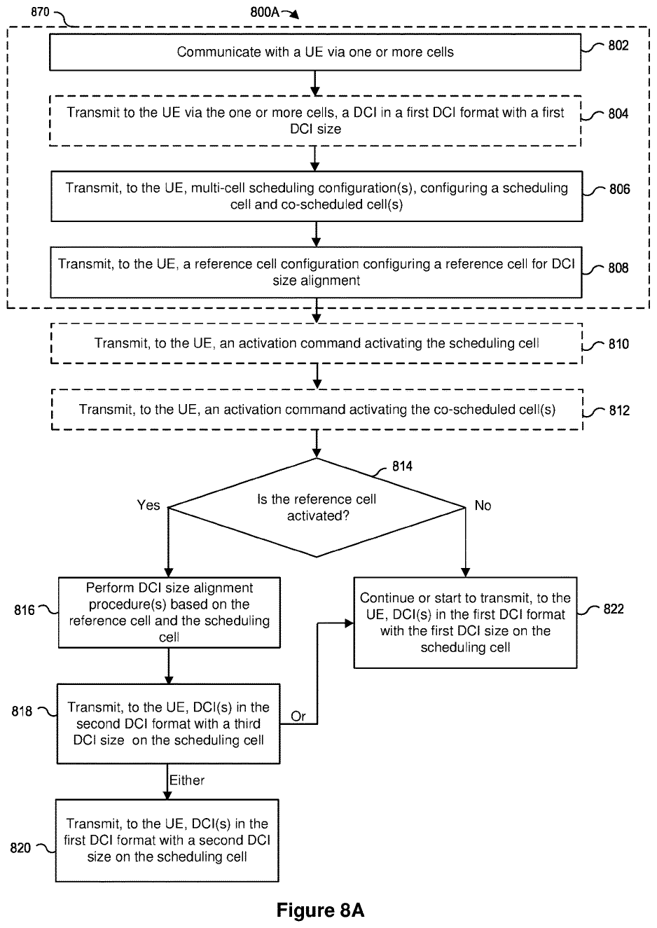

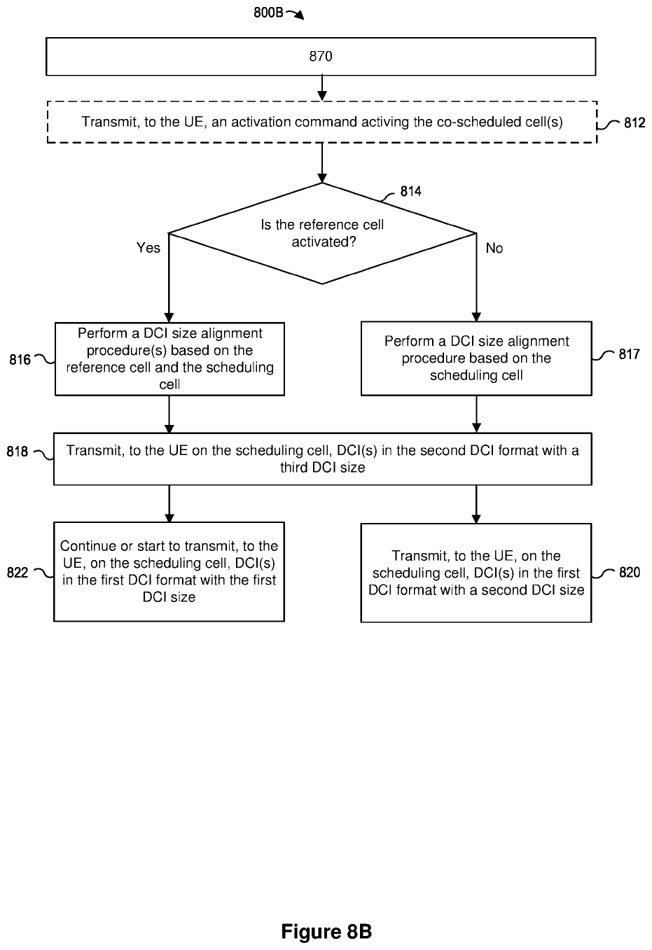

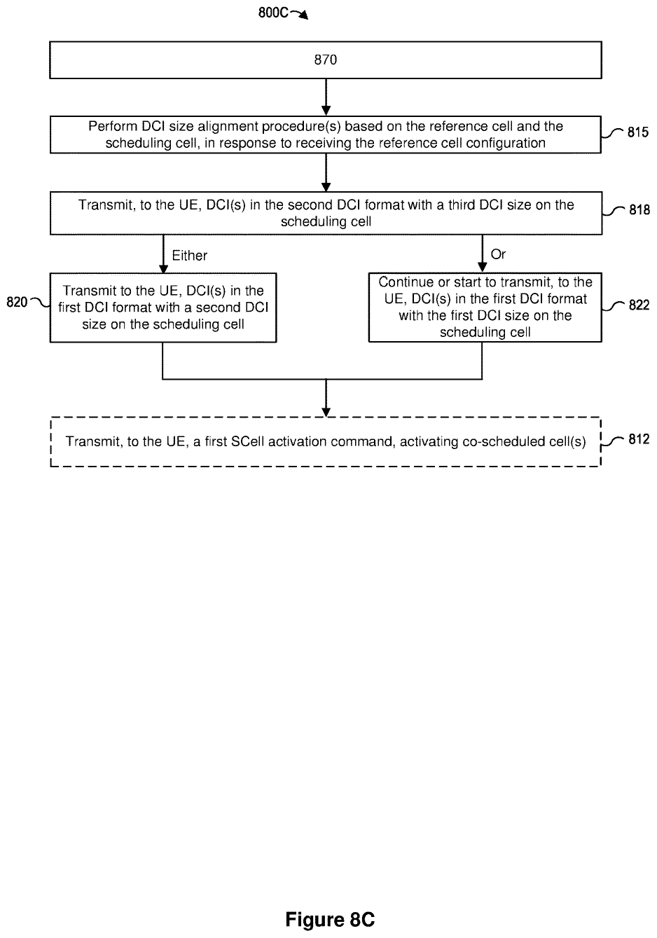

FIG. 8A is a flow diagram of an example method 800A for receiving single cell and multi-cell PDSCH transmission(s), which can be implemented by a base station. The method 800A begins at block 802, where the base station communicates with a UE via one or more cells (e.g., event 302). At block 804, the base station transmits to the UE via the one or more cells, DCI(s) in a first DCI format with a first DCI size (e.g., event 304). At block 806, the base station transmits to the UE, multi-cell configuration(s), configuring a scheduling cell and co-scheduled cell(s) (e.g., event 308). At block 808, the base station transmits to the UE, a reference cell configuration indicating a reference cell for DCI size alignment (e.g., event 310A, 310B). At block 810, the base station transmits, to the UE, an activation command activing the scheduling cell (e.g., events 312A, 313). At block 812, the base station transmits, to the UE, an activation command activing the co-scheduling cell(s) (e.g., events 312A, 312B, 313). At block 814, the base station determines whether the reference cell is activated. If the base station determines that the reference cell is activated at block 814, the flow proceeds to block 816. Otherwise, if the base station determines that the reference is not activated at block 814, the flow proceeds to block 822. At block 816, the base station performs DCI size alignment procedure(s) (e.g., events 320A, 320B, 326) based on the reference cell and scheduling cell. In some implementations, the DCI size alignment procedures include a first DCI size alignment procedure and a second DCI size alignment procedure. In such cases, the base station performs the first DCI size alignment procedure and the second DCI size alignment procedure based on the reference cell and the scheduling cell, respectively. In other implementations, the base station performs the DCI size alignment procedure (i.e., a single DCI size alignment procedure) based on the both the reference cell and the scheduling cell. At block 818, the base station starts to transmit, to the UE, DCI(s) in the second DCI format with the third DCI size on the scheduling cell (e.g., event 323). Then the flow can proceed either to block 820 or block 822. At block 820, the base station starts to transmit, to the UE, DCI(s) in the first DCI format with a second DCI size (e.g., event 321). At block 822, the base station continues or starts to transmit, to the UE, DCI(s) in the first DCI format with the first DCI size (e.g., event 327C).

Blocks 802, 804, 806 and 808 are collectively referred to in FIG. 8A as block 870.

FIG. 8B is a flow diagram of an example method 800B, similar to the method 800A. If the base determines that the reference cell is not activated at block 814, the flow proceeds to block 817. At block 817, the base station perform a DCI size alignment procedure based on the scheduling cell. In other words, when the reference cell is deactivated, the base station does not consider the reference cell in the DCI size alignment procedure.

FIG. 8C is a flow diagram of an example method 800C similar to the method 800A, except that the method 800C includes block 815 instead of block 814. At block 815, the base station performs DCI size alignment procedure(s) based on the reference cell and the scheduling cell, in response to receiving the reference cell configuration, i.e., regardless of whether the reference cell is activated or not. The flow then proceeds to block 818. The flow proceeds either to block 820 (e.g., event 321) or block 822 from block 818.

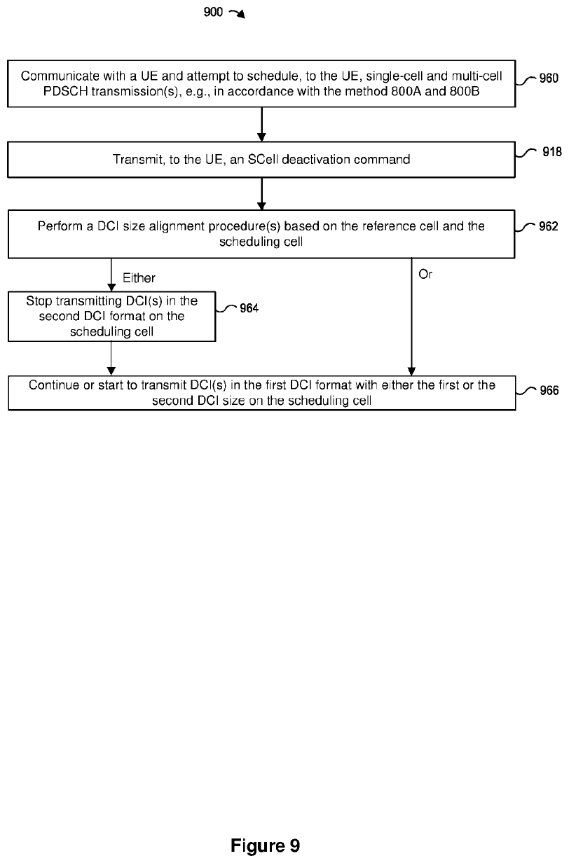

FIG. 9 is a flow diagram of an example method 900 for receiving single cell and multi-cell PDSCH transmission(s), which can be implemented by a base station. The method 900 begins at block 960, where the base station communicates with a UE, attempt to schedule single cell and multi-cell PDSCH transmission(s) by using methods 800A and 800B. At block 918, the base station transmits, to the UE, a SCell deactivation command (e.g., event 418, 518, 554). At block 962, the base station performs DCI size alignment procedure(s) (e.g., events 462, 468, 562A, 562B, 816). Then the flow can proceed either to block 964 or block 966. At block 964, the base station stops transmitting, to the UE, DCI(s) in the second DCI format on the scheduling cell (e.g., events 463, 563). At block 966, the base station continues or starts to transmit, to the UE, DCI(s) in the first DCI format with either the first (e.g., events 465, 468, 565, 822) or the second (e.g., events 468, 820) DCI size on the scheduling cell.

The following list of examples reflects a variety of the embodiments explicitly contemplated by the present disclosure.

### EXAMPLE 1

A method implemented in a radio access network (RAN) comprises transmitting, to a user equipment (UE), a multi-cell scheduling configuration including a scheduling cell and one or more co-scheduled cells, including scheduling the transmitting of the multi-cell scheduling configuration with a downlink control information (DCI) in a first DCI format; transmitting, to the UE, an indication of a reference cell for muti-cell scheduling; and transmitting, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference is activated.

### EXAMPLE 2

The method of example 1, further comprising: in response to determining that the reference cell is the scheduling cell, modifying a size for the first DCI format, from a first size to a second size.

### EXAMPLE 3

The method of example 2, further comprising: using a third size for the second DCI format, wherein the third size is different from the second size.

### EXAMPLE 4

The method of example 2 or 3, further comprising: transmitting a cell activation command that activates the reference cell, to cause the UE to start the monitoring in response to the receiving of the cell activation command.

### EXAMPLE 5

The method of example 2 or 3, wherein the UE starts the monitoring in response to the receiving of the indication of the reference cell.

### EXAMPLE 6

The method of example 1, further comprising: transmitting a cell activation command that activates the one or more co-scheduled cells and does not activate the reference cell; and in response to the transmitting of the cell activation command and determining that the reference cell is not the scheduling cell, modifying a size for the first DCI format.

### Example 7

The method of example 6, further comprising: transmitting, to the UE, a cell deactivation command for the reference cell; and continuing the transmitting of the multi-cell DCI on the scheduling cell; and continuing the transmitting of the single-cell DCI with the first DCI, including modifying the size for the first DCI format.

### EXAMPLE 8

The method of any of examples 2-6, further comprising: transmitting, to the UE, a cell deactivation command for the one or more co-scheduled cells; stopping the transmitting of the multi-cell DCI on the scheduling cell; and continuing the transmitting of the single-cell DCI using the first size with the first DCI.

### EXAMPLE 9

The method of any of examples 2-7, wherein the modifying of the size for the first DCI format includes: determining than a total number of sizes of DCIs to be monitored in the scheduling cells exceeds a threshold value; and modifying a size for the first DCI format so that the first DCI format with the modified size matches a length of at least one other DCI format.

### EXAMPLE 10

The method of example 1, wherein: the transmitting of the multi-cell scheduling configuration by the DCI in the first DCI format including using a first size for the first DCI format; the method further comprising: transmitting a cell activation command that activates the reference cell; in response to (i) the cell activation command and (ii) determining that the reference cell is not the scheduling cell, continuing using the first size for the first DCI format after the receiving of the indication of the reference cell.

### EXAMPLE 11

The method of example 10, further comprising: transmitting, to the UE, a cell deactivation command for the reference cell; and in response to the cell deactivation command: stopping the transmitting of the multi-cell DCI on the scheduling cell; and continuing the transmitting of the single-cell DCI using the first size for the first DCI.

The following description may be applied to the description above.

Generally speaking, description for one of the above figures can apply to another of the above figures. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configuration(s)” or “configuration parameter(s)”, and vice versa. In some implementations, “PDSCH” can be replaced by “PDSCH transmission” or “a transmission on a PDSCH”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The term “or” as used herein is to be interpreted as an inclusive or meaning any one or any combination, unless expressly indicated otherwise, mutually exclusive, or indicated otherwise by context. Therefore, herein, the expression “A or B” means “A, B, or both A and B.”

Upon reading this disclosure, those of skill in the art will appreciate still additional alternative structural and functional designs for managing multi-cell PDSCH transmissions through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

What is claimed is:

1. A method implemented in a user equipment (UE), the method comprising:
receiving, from a radio access network (RAN), a multi-cell scheduling configuration including a scheduling cell and one or more co-scheduled cells, the receiving of the multi-cell scheduling configuration scheduled by a downlink control information (DCI) in a first DCI format;
receiving, from the RAN, an indication of a reference cell for muti-cell scheduling; and
monitoring, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference cell is activated.

2. The method of claim 1, further comprising:
in response to determining that the reference cell is the scheduling cell, modifying a size for the first DCI format, from a first size to a second size.

3. The method of claim 2, further comprising:
using a third size for the second DCI format, wherein the third size is different from the second size.

4. The method of claim 2 or 3, further comprising:
receiving a cell activation command that activates the reference cell, wherein the UE starts the monitoring in response to the receiving of the cell activation command.

5. The method of claim 2 or 3, wherein:
the UE starts the monitoring in response to the receiving of the indication of the reference cell.

6. The method of claim 1, further comprising:
receiving a cell activation command that activates the one or more co-scheduled cells and does not activate the reference cell; and
in response to the cell activation command and determining that the reference cell is not the scheduling cell, modifying a size for the first DCI format.

7. The method of claim 6, further comprising:
receiving, from the RAN, a cell deactivation command for the reference cell; and
in response to the cell deactivation command:
continuing the monitoring the multi-cell DCI on the scheduling cell; and
continuing the monitoring of the single-cell DCI with the first DCI, including modifying the size for the first DCI format.

8. The method of any of claims 2-6, further comprising:
receiving, from the RAN, a cell deactivation command for the one or more co-scheduled cells;
in response to the cell deactivation command:
stopping the monitoring the multi-cell DCI on the scheduling cell; and
continuing the monitoring of the single-cell DCI using the first size with the first DCI.

9. The method of any of claims 2-7, wherein the modifying of the size for the first DCI format includes:
determining than a total number of sizes of DCIs to be monitored in the scheduling cells exceeds a threshold value; and
modifying a size for the first DCI format so that the first DCI format with the modified size matches a length of at least one other DCI format.

10. The method of claim 1, wherein:
the receiving of the multi-cell scheduling configuration by the DCI in the first DCI format including using a first size for the first DCI format;
the method further comprising:
receiving a cell activation command that activates the reference cell;
in response to (i) the cell activation command and (ii) determining that the reference cell is not the scheduling cell, continuing using the first size for the first DCI format after the receiving of the indication of the reference cell.

11. The method of claim 10, further comprising:
receiving, from the RAN, a cell deactivation command for the reference cell; and
in response to the cell deactivation command:
stopping the monitoring the multi-cell DCI on the scheduling cell; and
continuing the monitoring of the single-cell DCI using the first size for the first DCI.

12. The method of claim 1, wherein:
the receiving of the multi-cell scheduling configuration by the DCI in the first DCI format including using a first size for the first DCI format;
the method further comprising:
in response to determining that (i) the reference cell is not the scheduling cell, and (ii) prior to receiving a cell activation command, continuing the use the first size for the first DCI format after the receiving of the indication of the reference cell.

13. The method of any of claim 6, 10, or 12, further comprising:
receiving, from the RAN, a cell deactivation command for the one or more co-scheduled cells; and
in response to the cell deactivation command:
stopping the monitoring the multi-cell DCI on the scheduling cell; and
continuing the monitoring of the single-cell DCI using the first size for the first DCI.

14. A method implemented in a radio access network (RAN), the method comprising:
transmitting, to a user equipment (UE), a multi-cell scheduling configuration including a scheduling cell and one or more co-scheduled cells, including scheduling the transmitting of the multi-cell scheduling configuration with a downlink control information (DCI) in a first DCI format;
transmitting, to the UE, an indication of a reference cell for muti-cell scheduling; and
transmitting, in the scheduling cell, a single-cell DCI in the first DCI format and a multi-cell DCI in a second DCI format, the respective sizes for the first DCI format and the second DCI format based on one or more of (i) whether the reference cell is the scheduling cell, or (ii) whether the reference is activated.

15. A device comprising a transceiver and processing hardware, the device configured to implement a method of any of the preceding claims.
